(19) United States
(12) Patent Application Publication
(10) Pub. No.: US 2005/0281542 A1
(43) Pub. Date: Dec. 22, 2005

(54) Audio video system

(75) Inventor: Takehiro Toya, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd, Osaka (JP)

(21) Appl. No.: 11/153,055

(22) Filed: Jun. 15, 2005

(30) Foreign Application Priority Data
Jun. 21, 2004 (JP) 2004-182085

(51) Int. Cl. H04N 5/76; H04N 5/781

(52) U.S. Cl. 386/96; 386/125

(57) ABSTRACT

In a DVD reproduction device a controller detects the remaining time of a movie being reproduced and when it detects that the remaining time reaches a time stored in a memory it provides to a remote control transmitter the information stored in the memory and specifying household electrical equipment to be operated, and a control signal. The remote control transmitter outputs an infrared signal of a type corresponding to the household electrical equipment to start to drive the household electrical equipment. This allows a user having finished watching the movie to immediately take a bath, have coffee and/or the like.

### BACKGROUND OF THE INVENTION

1. Field of the Invention

The present invention relates generally to audio video systems and particularly to those including a digital versatile disk (DVD) reproduction device reproducing a video signal of a movie recorded on a disk.

2. Description of the Background Art

In a conventional method when VTR equipment starts to reproduce a movie the lighting is turned down and an electrically operated curtain is closed, and when the VTR equipment completes reproducing the movie the lighting is turned up and the curtain is also opened so as to provide an indoor environment suitable for watching the movie (see Japanese Patent Laying-Open No. 05-334863, for example).

Furthermore there is also a method for example moving a fan to blow wind or operating a cooler to reduce temperature or the like in synchronization with a scene of a movie to create an audio-visual environment matching the scene (see Japanese Patent Laying-Open No. 2002-010370 for example).

Furthermore after a movie has been watched there is a demand for taking a bath for relaxation, having coffee to enjoy the afterglow of the movie, taking some refreshments, or the like.

Conventionally, one needs to prepare a bath, coffee, refreshments or the like after the movie ends, which consumes time before they are ready.

### SUMMARY OF THE INVENTION

The present invention mainly contemplates an audio video system capable of controlling equipment to be operated so as to achieve a desired object when a movie ends.

The present audio video system includes a DVD reproduction device and a remote control transmitter. The DVD reproduction device includes: a video signal reproducer reproducing a video signal of a movie recorded on a disk; a first memory; a console operated to store to the first memory first information specifying equipment to be operated and second information indicating a desired time; and a first controller detecting a remaining time of the movie with the video signal reproduced by the video signal reproducer, and outputting the first information from the first memory if the remaining time detected reaches the desired time stored in the first memory and indicated by the second information. The remote control transmitter includes: a second memory having stored therein a table indicating a relationship between equipment to be operated and a type of an infrared signal applied to control the equipment; a second controller operative in response to the DVD reproduction device's first controller outputting the first information to read from the second memory the type of the infrared signal corresponding to the equipment to be operated specified by the first information, and output a drive signal in accordance the read type to start to drive the equipment to be operated specified by the first information; and a light emitter operative in response to the drive signal received from the second controller to emit light to transmit the infrared signal to the equipment to be operated specified by the first information.

In the present AV system information specifying equipment to be operated and a desired time are registered and when a movie's remaining time reaches the registered, desired time an infrared signal is responsively output to start to drive the registered equipment. By registering a desired time and equipment to be operated the equipment, can be controlled to achieve a desired object when the movie ends.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a configuration of the present AV system in one embodiment.

FIG. 2 is a block diagram of a configuration of a DVD reproduction device and a remote control transmitter shown in FIG. 1.

FIG. 3 is a flow chart of an operation of the AV system shown in FIGS. 1 and 2.

### BEST MODE FOR CARRYING OUT THE INVENTION

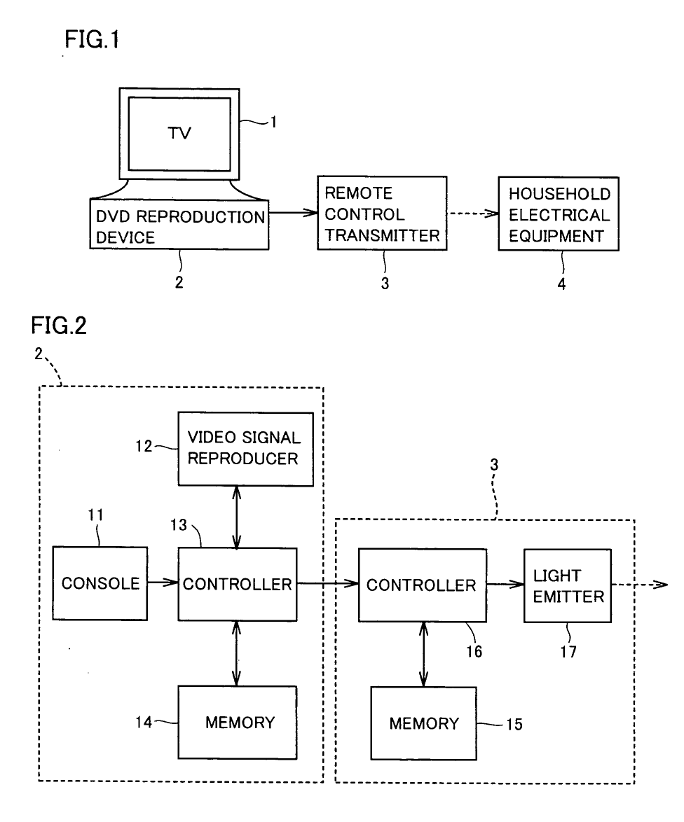

FIG. 1 is a block diagram showing a configuration of the present AV system in one embodiment. In the figure, the AV system includes a television (TV) receiver 1, a DVD reproduction device 2 and a remote control transmitter 3. When a movie being reproduced has a remaining time as predetermined the AV system responsively starts to drive household electrical equipment 4, such as a bath boiler, a coffee maker, a toaster, an electric rice cooker, and the like.

More specifically, TV receiver 1 for example displays an image of a program of a channel selected via a tuner or displays a movie or the like in response to a video signal reproduced by DVD reproduction device 2. With reference to FIG. 2, DVD reproduction device 2 includes a console 11, a video signal reproducer 12, a controller 13, and a memory 14. Console 11 is operated by a user to reproduce and stop a movie recorded on a disk, eject the disk, and provide similar operation as well as register information (e.g., maker, equipment type, type number, and the like) that specifies household electrical equipment 4 to be operated, and information indicating a period of time TR elapsing after the AV system starts to drive household electrical equipment 4 and before the movie ends.

Video signal reproducer 12 is controlled by controller 13 for example to reproduce a video signal of a movie recorded on a disk. Memory 14 stores therein information input via console 11 and specifying household electrical equipment 4 to be operated, and information indicating time TR. Controller 13 operates in response to a signal received from console 11 to control video signal reproducer 12 and also detects the remaining time of the movie being reproduced. If the remaining time detected is time TR stored in memory 14, controller 13 responsively provides remote control transmitter 3 with the information stored in memory 14 and specifying household electrical equipment 4 to be operated and also issues a control signal to the transmitter to start to drive household electrical equipment 14.

Remote control transmitter 3 includes a memory 15, a controller 16 and a light emitter 17. Household electrical equipment 4 is controlled by an infrared signal, which varies in type by maker, equipment type, type number, and the like. Memory 15 has stored therein a table indicating a relationship between makers, equipment types, type numbers and the like, and the infrared signal's types. When controller 16 receives the information specifying household electrical equipment 4 and the control signal from the DVD reproduction device 2 controller 13, controller 16 responsively reads from memory 15 a type of the infrared signal that corresponds to household electrical equipment 4, and in accordance with the read type issues a drive signal to light emitter 17 to start to drive household electrical equipment 4. In response to the drive signal light emitter 17 emits light and outputs to a light receptor of household electrical equipment 4 an infrared signal having a waveform corresponding to the type read from memory 15.

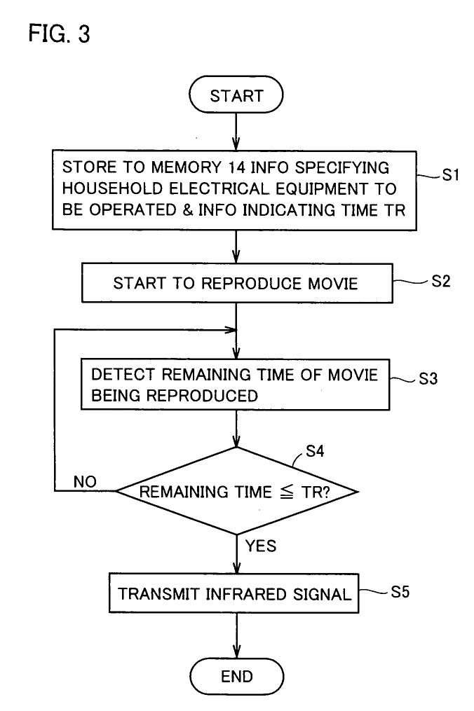

FIG. 3 is a flow chart of an operation of the AV system shown in FIGS. 1 and 2. In FIG. 3 at step S1 controller 13 stores to memory 14 information input via console 11 and specifying household equipment 4 to be operated (e.g., company A, bath boiler, type B) and information indicating time TR desired (e.g., a period of time of 30 minutes required to get the bath ready). At step S2 controller 13 controls video signal reproducer 12 to start to reproduce a movie recorded on a disk.

Then at step S3 controller 13 detects the movie's remaining time from a signal received from video signal reproducer 12. Then at step S4 controller 13 determines whether the remaining time detected at step S3 is not larger than time TR indicated by information stored in memory 14. If the remaining time is larger than TR the control returns to step S3. Otherwise the control goes to step S5. At step S5 controller 13 outputs the information specifying household electrical equipment 4 and the control signal and causes remote control transmitter 3 to transmit an infrared signal to start to drive household electrical equipment 4. Thus when the movie ends the bath is ready so that after the user has finished watching the movie the user can immediately take the bath for relaxation.

If at step S1 a coffee maker and a prescribed period of time are registered, coffee can be ready when the movie ends, and the user can immediately have the coffee and thus enjoy the afterglow of the movie. Furthermore, if a toaster and a prescribed period of time are registered, then toast can be ready when the user has finished watching the movie. Furthermore, if an electrical rice cooker and a prescribed period of time are registered, then cooked rice can be ready when the user has finished watching the movie.

Although the present invention has been described and illustrated in detail, it is clearly understood that the same is by way of illustration and example only and is not to be taken by way of limitation, the spirit and scope of the present invention being limited only by the terms of the appended claims.

1. An audio video system comprising:
a DVD reproduction device including
a video signal reproducer reproducing a video signal of a movie recorded on a disk,
a first memory,
a console operated to store to said first memory first information specifying equipment to be operated and second information indicating a desired time, and
a first controller detecting a remaining time of the movie with the video signal being reproduced by said video signal reproducer, and outputting said first information from said first memory if the remaining time detected reaches said desired time stored in said first memory and indicated by said second information; and
a remote control transmitter including
a second memory having stored therein a table indicating a relationship between equipment to be operated and a type of an infrared signal applied to control the equipment,
a second controller operative in response to said DVD reproduction device's first controller outputting said first information to read from said second memory the type of the infrared signal corresponding to the equipment to be operated specified by said first information, and output a drive signal in accordance the read type to start to drive the equipment to be operated specified by said first information, and
a light emitter operative in response to said drive signal received from said second controller to emit light to transmit the infrared signal to the equipment to be operated specified by said first information.

2. An audio video system comprising:
video signal reproduction means for reproducing a video signal of a movie recorded in a storage medium;
registration means for registering equipment to be operated and a desired time;
detection means for detecting a remaining time of the movie with the video signal being reproduced by said video signal reproduction means, and outputting a control signal in response to the remaining time detected reaching the desired time registered with said registration means; and
transmission means operative in response to said detection means outputting said control signal for transmitting a remote control signal to start to drive the equipment to be operated registered with said registration means.

3. The AV system according to claim 2, wherein said video signal reproduction, registration and detection means are included in a digital versatile disk reproduction device.
